(19) United States
(12) Patent Application Publication
(10) Pub. No.: US 2018/0050284 A1
(43) Pub. Date: Feb. 22, 2018

(54) CAPSULE INTENDED FOR A LIQUID FLOW COMPRISING AN INNER CASING AND AN OUTER UNIT

(71) Applicant: ORBITAL SYSTEMS AB, MALMÖ (SE)

(72) Inventors: Amir Mehrdad MAHDJOUBI NAMIN, MALMÖ (SE); Krister UVNÄS, SÖDRA SANDBY (SE); Ragnar Lennart SJÖSTEDT, ÅRYD (SE); Dag Eskil REIMHAGEN, MALMÖ (SE)

(21) Appl. No.: 15/555,734

(22) PCT Filed: Mar. 3, 2016
(86) PCT No.: PCT/SE2016/050168

§ 371 Date: Sep. 5, 2017

(30) Foreign Application Priority Data
Mar. 9, 2015 (SE) 1550285-9

(51) Int. Cl. B01D 27/08; B01D 35/31

(52) U.S. Cl. CPC B01D 27/08; E03B 7/074; B01D 35/31

(57) ABSTRACT

The present invention describes a capsule (1) intended for a liquid flow, said capsule (1) comprising an inner casing (2) which is encasing liquid processing means and the liquid flow passing the liquid processing means, and which inner casing (2) is open for inflow and outflow of liquid into and out from the capsule (1); an outer unit (3) which has means having a pressure up-taking ability for the inner casing (2), wherein the inner casing (2) and outer unit (3) may be totally separated from each other, and wherein the inner casing (2) may function as a disposable part of the capsule (1).

### FIELD OF THE INVENTION

The present invention relates to a device intended for processing of a liquid stream, such as for the purification of a water flow.

### TECHNICAL BACKGROUND

There are many types of devices intended for processing, such as e.g. purification, of liquid streams, e.g. filter devices. The existence of so many different types of course depends on the many different possible usages. For instance, there are oil filters for automotives and water filters intended e.g. for households and sanitary applications in general, e.g. in showers, sinks, etc. The present invention is directed to filters intended for filtration of liquid flows. The flows may hold particular material which should not be allowed to pass the filter, but also very small objects, such as bacteria etc. may be the intended source to also remove from the liquid flow when filtering the same. The present invention is in particular directed to water filters intended for sanitary purposes, such as on incoming water piping to houses or buildings etc. or in different sanitary arrangements, such as in shower systems, sinks or the like. Moreover, the water filters according to the present invention also fins use in hybrid filtration devices which devices have the ability to shift between a recirculation mode or a discharging mode and where quality of the flow at a certain time decides which mode should be held a certain time.

With reference to water filters there are extremely many different types on the market today. As an example of a described water filter, there is for instance one disclosed in DE102010001085A1. This water filter has a terminal housing provided with an input port, where a manometer connection is provided either above or below the terminal housing. Another manometer connection is provided on a front side or rear side of the terminal housing for closing a manometer. The manometer indicates the water pressure within the area of an output port. The intended usage of this water filter is in particular for a drinking water house installation. A very different type of water filter is for instance disclosed in US 2012/0103910. This filter comprises a closed shell, a filter media and a valve. The closed shell has an inlet and an outlet. The filter media is within the shell and arranged such that water flowing from the inlet to the outlet passes through the filter media. The filter media is arranged to filter hydrocarbons from the water to reduce the proportion of hydrocarbons in water exiting the water filter to below a predetermined threshold.

One aim of the present invention is to provide a device intended for processing of liquid flows which is simple to replace when a device is consumed. Furthermore, the device is disposable and replaceable in an effective way with minimum contamination risk. Moreover, the device according to the present invention provides an effective solution to use in water processing systems, such as e.g. for filter systems.

### SUMMARY OF THE INVENTION

The stated purpose above is achieved by a capsule intended for a liquid flow, said capsule comprising an inner casing which is encasing liquid processing means and the liquid flow passing the liquid processing means, and which inner casing is open for inflow and outflow of liquid into and out from the capsule; an outer unit which has means having a pressure up-taking ability for the inner casing during use, wherein the inner casing and outer unit may be totally separated from each other, and wherein the inner casing may function as a disposable part of the capsule, hence the possibility of referring to the inner casing as a ‘Capsule-refill’.

It should be noted that the outer unit may only support one portion or more of the actual inner casing. The inner casing may as such also have at least some pressure up-taking ability in itself. This ability is provided by the enclosure of the inner casing as such, and may also be enforced by using certain materials, enforcement portions or the like. Nevertheless, the outer unit is always provided to be in close contact with at least one part of the inner casing, during use, so as to pressure support and pressure enforce at least a portion of the inner casing. As such, the actual pressure up-taking ability implies that the outer unit is able to function as a pressure support of at least a part of the inner casing when the inner casing is pressurized.

The pressure up-taking ability according to the present invention is very different from many other pressure-resistant solutions. For instance, in JP2001107428A there is disclosed a water purifier and cartridge therefore. The cartridge can be removed from an outer case as in most solutions using filter cartridges. The outer case is formed of a water-pressure-resistant material intended to stand hydraulic pressure of tap water without bursting. This pressure resistance refers to water pressure as such and is provided by use of a certain material.

The pressure up-taking ability provided according to the present invention, however, refers to the physical pressure inside of the inner bag. The present invention provides an arrangement where the outer unuit can support the inner casing to take up this pressure inside of the inner bag. This is very different from the solution provided in JP2001107428A.

Furthermore, it should be noted that although the inner casing and outer unit may be separated from each other, the outer unit is always provided to be in close contact with at least one part of the inner casing during use to ensure to provide the pressure up-taking ability for the inner casing.

Furthermore, it should be noted that the expression “is encasing” does not imply a total isolation of the inner casing as such. The inner casing will have opening connections so it is possible to connect to connections of the liquid flow going into and out from the inner casing.

### BRIEF DESCRIPTION OF THE DRAWINGS

FIG. 1a and 1b show the inner casing and the outer unit, respectively, according to one embodiment of a capsule according to the present invention.

FIG. 2 shows a capsule according to one embodiment of the present invention, in this case when an inner casing is enclosed in an outer casing.

### SPECIFIC EMBODIMENTS OF THE INVENTION

Below, some specific embodiment of the present invention are disclosed and discussed.

According to one specific embodiment of the present invention, the liquid processing means is a liquid purification means, e.g. one or more filters. According to one specific embodiment of the present invention, the liquid processing means is one liquid filter, such as a water filter.

In relation to disposable filters, U.S. Pat. No. 4,986,912 may be mentioned. In U.S. Pat. No. 4,986,912 there is disclosed a disposable filter bag insert for use in a filter canister assembly that comprises a rigid ring of diameter to overlie a shoulder on the canister and be sealingly captured between the canister base and top. A filter stock of sheet stock construction is suspended from the ring and has a lock stitch extending along the bottom and one side edge thereof. A section of oil-adsorbent material is likewise suspended from the ring, but covers less than the entire surface area of the sock, such that fluid flow through the sock continues even if the oil-adsorbent material becomes clogged. The sock lock stitch is specially contoured where it is looped over the ring for enhanced sealing capture between the canister top and base.

In comparison to U.S. Pat. No. 4,986,912 it should be mentioned that the present invention is directed to providing an inner casing which encloses the liquid flow to process from an outer unit. For instance, when incorporating a filter in the capsule according to the present invention, then the filter and the liquid being filtered is enclosed in the inner casing and as such never intended to be in contact with the outer part or cover of the capsule. This is not the case with the device disclosed in U.S. Pat. No. 4,986,912. Moreover, the disposable feature is not the same according to the present invention as in U.S. Pat. No. 4,986,912. According to the present invention, the inner casing is the disposable part. According to U.S. Pat. No. 4,986,912 the filter bag as such is the disposable.

As hinted above, the outer unit according to the present invention may be of many different types, the only common feature being the pressure up-taking support provided to the inner casing when being in place. According to one specific embodiment of the present invention, the outer unit is an end piece to the inner casing. In this case, the end piece may be provided outside of the top or bottom of the inner casing but also along a side of the inner casing. Furthermore, according to this embodiment of the present invention, the inner casing is typically also provided with an end piece provided with connection openings for inflow and outflow of media from the capsule. This is totally dependent on the geometry and design of the inner casing and also the type of plug-in solution for the capsule used in the system. In relation to the embodiment disclosed above it may further be said that an end piece of the inner casing also may be provided with pressure up-taking ability.

According to yet another specific embodiment of the present invention, the outer unit is an outer casing and wherein the inner casing is enclosed in the outer casing during use. Also in this case it is important to understand that one part of the outer unit or outer casing may be an open part so the enclosure does not imply an isolation of the inner casing. Fact is that openings for the inflow and outflow connections must be provided so that liquid can flow both into the inner casing and out from the same after the liquid have been processed. When the outer unit is a total enclosure of the inner casing, then the outer casing must be openable. Such an openable feature may be provided by different means, such as by threaded connections or plug-in features of one part into another, etc.

As disclosed above, the inner casing should be impermeable. There are many different possible versions of inner casings according to the present invention. As shown in the figures, a bag is possible, and also a tube. Furthermore, a tube provided with one or more end pieces are also possible. In the case of only one end piece then the outer unit has to provide for the other end piece. All different versions are possible, the common feature of the inner casing according to the present invention is that at least a part of it is provided in the form of a bag or a tube, having an open end for inflow and outflow of liquid. As one example, the open end may be the end that is connected to an end piece of the capsule. According to another specific embodiment, the connection may be from the side of the capsule and then an open part of the bag or tube may be directed to the side of the capsule.

Moreover, also other properties of the inner casing may vary. For instance, many different materials may be used. One example when employing a bag is flexible plastic materials, such as polyethylene or the like. A flexible bag material provides advantages. When such a bag is pressurized, then the bag has an ability to stretch without collapsing. Moreover, such materials may also be employed in a comparatively low thickness which is cost effective.

As mentioned, also the outer unit may have different shape and other properties. According to one embodiment of the present invention, the outer unit is an outer casing being gas permeable. In the case of an outer casing which encloses the inner casing, such as a bag, then the outer casing should have the possibility of evacuating air or other media positioned outside of the inner casing. Moreover, also features relating to the position of the inner casing in relation to the outer unit are of interest. According to one embodiment, the inner casing is arranged with narrow slits relative to the outer unit so that the risk of a collapse of the inner casing during pressurization is minimized. The slits important to eliminate can be of different type. A first type is the slits between the actual “wall” of the inner casing and the “wall” of the outer unit. These slits may not be that wide so the material of the inner casing does not have the possibility to stretch that much that is needed. For instance especially in the corners there is a higher risk of having a wider slits, and this is important to control according to the present invention. The possible width of the slits in e.g. a corner, if there is any corner, depends on the material used for the inner casing. For instance a flexible plastic material of a bag has the possibility to stretch which also diminishes the risk for the bag to collapse.

A second possible type of slits is between a possible end piece and sides of an outer casing. As mentioned, the outer casing is preferably gas permeable so that air outside an inner bag is possible to evacuate. However, a slits large enough between e.g. the end piece and wall of the outer casing so that the inner bag can be pressed and penetrate out from such a slits should be avoided according to the present invention.

When a bag or similar type of inner casing is arranged in the capsule according to the present invention, also such a bag may have different features and properties. One feature of interest is the thickness of the actual bag. It is of course of interest to keep the material thickness as low as possible. When using for instance a flexible plastic material, then the thickness may be as low as below 0.3 mm, e.g. around 0.15 mm. Even lower thicknesses are possible, and the thickness possible to employ depends on other properties of the capsule, such as type of outer casing and type of and width of slits which are provided, etc. Furthermore, the bag may also be coloured. The bag may contain a filter intended to filter a water flow. As such, there is a risk of having dirt and components etc. within the bag. If the bag is coloured then this is not visualized in the same way, which may be of interest.

Furthermore, the inner casing may have a foldable and unfoldable bottom. This is also a feature of a bag which is of interest to avoid for the same to collapse. When the bag is pressurized it is beneficial that the bag has the ability to unfold to be placed against the outer unit to get the pressure support. For instance, a foldable bottom of a bag may ensure that the bag is pressed out against an end piece of the outer unit or out towards the bottom of an outer casing to “fill up” the inner corners of the outer casing.

In relation to the above described it may also be said that when processing water, such as for purification of water, e.g. by use of one or more filters, then it is of interest to hold both a high pressure of the water flow and a comparatively high temperature. For instance in a shower system, such as a hybrid shower having the ability of allowing purification and either recycling of water or discarding of water depending on the quality of the water flow at a certain time and place, it is of interest to hold a high pressure to ensure an enough high flow capacity. Moreover also the temperature should be possible to hold at a high level so that certain bacteria etc. are killed. As an example, levels up to 8 bar pressure and 65° C. in temperature are of interest in such systems.

Moreover, the inner casing may also hold a sponge in a bottom of the inner casing, such as in the bottom of an inner bag. The sponge is compressed or may be compressed when the inner casing is installed in the capsule according to the present invention. When replacing an inner casing i.e. replacement of a capsule refill, with a new one, then the sponge may absorb any liquid contained and then the inner casing does not have to be emptied totally. Moreover, the sponge could also function as a spring so that the entire unit is pushed out when replacing the same.

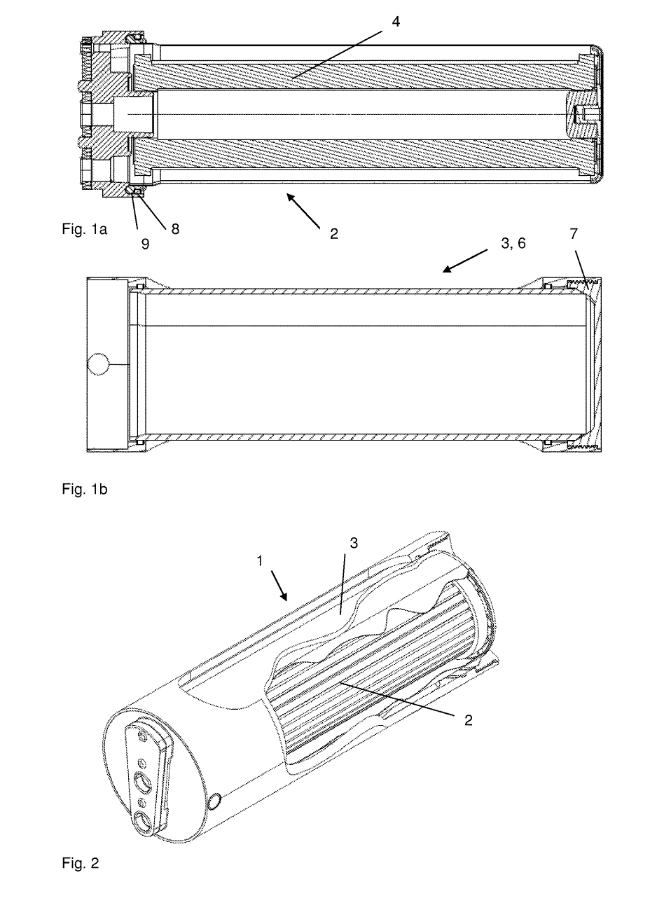

The fastening or attaching of inner casing and outer unit may vary. This is of course also totally dependent on the type of components used and e.g. if the outer unit is an enclosure or for instance only an end piece. In the case of an arranging an outer casing, then e.g. threaded fastening means may be employed. In virtue thereof, according to one specific embodiment of the present invention, the outer unit is an outer casing having one opening which is threaded to be fastened in the capsule. When viewing FIG. 1b this is shown in the right end being “a bottom end” of the outer casing. It should of course be understood that also very other types of variants are totally possible according to the present invention. For instance, the entire outer casing may be provided in one piece by injection moulding so that there is no threads provided in the right end of the outer casing. Such a moulded one-piece outer casing may be a plug-in device in a capsule according to one embodiment of the present invention.

In relation to the fastening, then the relationship between the outer unit and inner casing should of course also be discussed. With or without threads of the “bottom end” of an outer casing, also the fastening of the other end of such an outer casing may have a threaded end.

Moreover, the actual securing of the inner casing may be performed by different means. According to one specific embodiment of the present invention, the inner casing is sealed with an O-ring gasket. The sealing is performed to the end piece of the inner casing piece, such as shown with an example in FIG. 1a. Moreover, according to yet another specific embodiment, the inner casing is a bag which is sealed by being extended on the inside of and around an end of the inner casing in the capsule.

The capsule may also be provided with additional means. One example is a transport locking device. Another fastening means that may be arranged as a complement is a locking arm for the entire capsule. Such a locking arm may e.g. be arranged as a pivotable locking arm function as an eccentric lever. According to one embodiment both the transport locking device and the locking arm are arranged together as complementary locking means. By using such additional means, then the end piece of the capsule according to the present invention is complemented with means possible to bear a major part of the pressure forces being applied. This may be of interest as it increases the degree of freedom with respect to the design and properties of the end piece(s) of the inner casing.

The capsule according to the present invention may be arranged in many different types of systems. According to one specific embodiment of the present invention, the outer unit is a fixated part of a system having a liquid processing unit. In such a case the outer unit or outer casing may be a unit which is not intended to be loosened from the system when replacing an inner casing of the capsule.

Furthermore, according to one specific embodiment, the capsule also comprises a light unit intended for neutralisation of organisms in a water flow. The light unit may be contained inside of the inner casing, e.g. inside of a bag, however in this case then not in direct contact with the water being treated. In such a case, the light unit may be contained inside of a tube or the like. Furthermore, the light unit may also be positioned outside of the inner casing/bag. Regardless, this alternative has the benefit of keeping the water flow inside of the inner casing/bag and therefore all contaminants are kept inside of this inner bag.

Moreover, the light unit can be one UV lamp or any other form of UV unit, e.g. one or more UV LED units. The light unit is a disposable that has to be changed when consumed.

Furthermore, the capsule according to the present invention may be employed in many different types of applications. According to one specific embodiment of the present invention, the capsule is arranged in a water processing system. For instance a capsule with an inner casing holding a filter is one alternative of great interest in relation to the present invention.

The capsule and a system including the capsule according to present invention may be used in any kind of suitable liquid system, however aqueous systems are of special interest. Especially in systems intended for water processing, e.g. water purification. For instance, water sanitary systems, such as showers or sinks are interesting systems in which the capsule according to the present invention finds use. One example is sanitary systems employing filtering as a means for purifying the water. Moreover, also hybrid devices allowing purification and either recycling of water or discarding of water are alternatives where the capsule according to the present invention is of great interest. One such example is a hybrid shower or sink in which filter is used as the processing means. In such a system the capsule according to present invention is a very effective choice. The capsule according to the present invention provides a plug-in solution which is simple to dispose and replace with a new inner casing containing a new filter. In systems where the filters are used highly there is a great advantage in using the capsule according to the present invention. The capsule according to the present invention is not only simple to replace but may also provide a hygienic solution to the entire cycle when replacing the inner casing. The end piece of the inner casing provides a grip effective unit when replacing the same. As such, tools are possible to use instead of hands. Furthermore, a filter inside of the inner casing may be arranged so as to have the liquid flow running from inside out. As such, the actual dirt and contaminants may be collected inside of the actual filter. Moreover, also a valve may be arranged on the inflow and outflow so that the remaining water will stay in place and not flow out when the capsule is replaced.

In relation to the present invention it may further be mentioned that not only filters are possible processing means to provide inside of the inner casing. As an example, the inner casing may be provided with different compartments holding different substances or cartridges of interest to affect a liquid flow. There are many possible example, totally dependent on the liquid flow being processed.

### DETAILED DESCRIPTION OF THE DRAWINGS

In FIGS. 1a and 1b there is shown the inner casing 2 and the outer unit 3, respectively, according to one embodiment of a capsule 1 according to the present invention. The inner casing 2 is shown as in the upper view. The inner casing 2 is in this case enclosing a liquid processing means in the form of a filter 4. Moreover, the actual inner casing in this case is an impermeable bag fastened to an end piece (on the left side). The end piece has openings for connection to the inflow and outflow of the liquid going into and out from the inner casing 2.

In the lower FIG. 1b there is shown an outer unit 3 in the form of an outer casing 6 in this case. The inner casing 2 is possible to insert into the outer casing 6 to form a capsule 1 according to one embodiment of the present invention.

As notable, the inner casing 2 according to the embodiment of the present invention shown in FIG. 1a has an end piece. The bag of the inner casing 2 is sealed with an O-ring gasket 8. Moreover, the inner casing 2 is a bag which is sealed by being extended on the inside of and around an end 9 of the inner casing 2. A turned ring may arrange the bag of the inner casing 2 in an O-ring groove.

Furthermore, the outer casing 6 has according to this embodiment shown in FIG. 1b an opening 7 which is threaded to be fastened in the capsule 1.

FIG. 2 shows a capsule 1 according to another embodiment of the present invention. In the capsule 1, an inner casing 2 in the form of a tube is inserted in an outer unit 3.

As notable from above, there are many different variants of the capsule according to the present invention. For instance the outer pieces may be part of the inner casing and/or outer casing depending on the capsule as such. Nevertheless, the common feature of all capsules according to the present invention is the combination of an inner casing enclosing a liquid and liquid processing means and an outer unit being able to provided pressure up-taking support to the inner casing.

To provide one specific example, the capsule according to the present invention may be in the form of a filter casing unit. The filter casing unit may comprise an inner casing which is encasing a filter and all liquid passing the filter. The inner casing can have a closed bottom or side and the inner casing is connected to an open end of the filter casing unit. The open end of the filter casing unit may have two openings, one opening for a connection for incoming liquid to the filter and the other opening for a connection for outgoing liquid after the filter. Moreover, such a filter casing unit also then comprises an outer unit or an outer casing as disclosed above.

1. Capsule intended for a liquid flow, said capsule comprising
an inner casing which is encasing liquid processing means and the liquid flow passing the liquid processing means, and which inner casing is open for inflow and outflow of liquid into and out from the capsule;
an outer unit which has means having a pressure up-taking ability for the inner casing,
wherein the inner casing and outer unit may be totally separated from each other, and wherein the inner casing may function as a disposable part of the capsule.

2. Capsule according to claim 1, wherein the liquid processing means is a filter.

3. Capsule according to claim 1, wherein the outer unit is an end piece to the inner casing.

4. Capsule according to claim 1, wherein the outer unit is an outer casing and wherein the inner casing is enclosed in the outer casing during use.

5. Capsule according to claim 1, wherein the inner casing is an impermeable bag or tube having an open end for inflow and outflow of liquid.

6. Capsule according to claim 1, wherein the outer unit is an outer casing being openable.

7. Capsule according to claim 1, wherein the outer unit is an outer casing being gas permeable.

8. Capsule according to claim 1, wherein the inner casing is arranged with narrow slits relative to the outer unit so that the risk of a collapse of the inner casing during pressurization is minimized.

9. Capsule according to claim 1, wherein the inner casing has a foldable and unfoldable bottom.

10. Capsule according to claim 1, wherein the outer unit is an outer casing having one opening which is threaded to be fastened in the capsule.

11. Capsule according to claim 1, wherein the inner casing is sealed with an O-ring gasket.

12. Capsule according to claim 1, wherein the inner casing is a bag which is sealed by being extended on the inside of and around an end of the inner casing in the capsule.

13. Capsule according to claim 1, wherein the inner casing holds a sponge in a bottom of the inner casing.

14. Capsule according to claim 1, wherein the outer unit is a fixated part of a system having a liquid processing unit.

15. Capsule according to claim 1, also comprising a light unit intended for neutralisation of organisms in a water flow.

16. Use of a capsule according to claim 1, for water processing.

17. Hybrid device allowing purification and either recycling of water or discarding of water, wherein the hybrid device comprises a capsule according to claim 1.

18. Hybrid device according to claim 17, wherein the hybrid device is a shower or a sink.
